(19) United States
(12) Patent Application Publication
(10) Pub. No.: US 2023/0079968 A1
(43) Pub. Date: Mar. 16, 2023

(54) DAMPING-FORCE GENERATION MECHANISM AND PRESSURE SHOCK ABSORBER

(71) Applicant: Hitachi Astemo, Ltd., Hitachinaka-shi (JP)

(72) Inventors: Gota NAKANO, Hitachinaka-shi (JP); Chikara YANAGISAWA, Hitachinaka-shi (JP)

(73) Assignee: Hitachi Astemo, Ltd., Hitachinaka-shi (JP)

(21) Appl. No.: 18/054,748

(22) Filed: Nov. 11, 2022

Related U.S. Application Data
(63) Continuation of application No. PCT/JP2020/025105, filed on Jun. 25, 2020.

(51) Int. Cl. F16F 9/34

(52) U.S. Cl. CPC F16F 9/34; F16F 2222/12

(57) ABSTRACT

A damping-force generation mechanism includes: a first flow path forming portion forming a flow path in which a fluid flows; a first valve configured to control a flow of the fluid in the flow path; a back pressure chamber forming portion forming a back pressure chamber configured to apply a back pressure to the first valve; a second flow path forming portion including a plurality of connection flow paths connected to the back pressure chamber; and a second valve provided to face the second flow path forming portion and configured to control flows of the fluid in the plurality of connection flow paths.

### CROSS-REFERENCE TO RELATED APPLICATION

This application is a Continuation of International Patent Application No. PCT/JP2020/025105 filed on Jun. 25, 2020, the content of which is incorporated herein by reference in its entirety.

### FIELD OF THE INVENTION

The present invention relates to a damping-force generation mechanism and a pressure shock absorber.

### BACKGROUND OF THE INVENTION

For example, Patent Literature 1 discloses a damping-force adjusting type hydraulic shock absorber that generates a damping force by controlling a flow of an oil liquid, which is generated between an annular oil path and a reservoir due to sliding of a piston inside a cylinder, by a main valve and a pressure control valve of a back pressure type.

### CITATION LIST

Patent Literature 1: JP-A-2009-281584

In order to control valve opening characteristics of a damping valve for adjusting a damping force by a back pressure chamber, a flow of a fluid in a connection flow path connected to the back pressure chamber may be controlled by a valve. Here, in order to control the flow of the fluid in the connection flow path, it is considered to adjust an opening degree of the connection flow path by a valve. However, in a state where the opening degree of the valve with respect to the connection flow path is relatively small, an amount of change in opening area of the connection flow path changed by the valve according to a flow rate of the fluid flowing through the connection flow path is large. Therefore, in a state where the opening degree of the valve with respect to the connection flow path is relatively small, it is difficult to control the flow of the fluid in the connection flow path by the valve.

An object of the present invention is to facilitate control of a valve on a flow of a fluid in a connection flow path, which is connected to a back pressure chamber, in a state where an opening degree of the valve with respect to the connection flow path is small.

### SUMMARY OF THE INVENTION

For this purpose, the present invention provides a damping-force generation mechanism including: a first flow path forming portion forming a flow path through which a fluid flows; a first valve configured to control a flow of the fluid in the flow path; a back pressure chamber forming portion forming a back pressure chamber configured to apply a back pressure to the first valve; a second flow path forming portion including a plurality of connection flow paths connected to the back pressure chamber; and a second valve provided to face the second flow path forming portion and configured to control flows of the fluid in the plurality of connection flow paths.

According to the present invention, it is easy to control the flow of the fluid in the connection flow path by the valve in a state where the opening degree of the valve with respect to the connection flow path connected to the back pressure chamber is small.

### BRIEF DESCRIPTION OF THE DRAWINGS

FIG. 1 is an overall view of a hydraulic shock absorber according to a first embodiment.

FIG. 2 is a cross-sectional view of an outer damper according to the first embodiment.

FIG. 3 is a partial cross-sectional view of a main valve part and a damping force adjusting part according to the first embodiment.

FIG. 4A is a view illustrating a pilot valve and a pilot valve seat according to the first embodiment.

FIG. 4B is a view illustrating a pilot valve and a pilot valve seat according to the first embodiment.

FIG. 5 is a view illustrating the pilot valve seat according to the first embodiment.

FIG. 6A is a view illustrating operations of the hydraulic shock absorber of the first embodiment.

FIG. 6B is a view illustrating operations of the hydraulic shock absorber of the first embodiment.

FIG. 7A is a view illustrating flows of oil in the outer damper of the first embodiment.

FIG. 7B is a view illustrating flows of oil in the outer damper of the first embodiment.

FIG. 8 is a view illustrating a damping force adjusting part to which a second embodiment is applied.

FIG. 9A is a view illustrating a damping force adjusting part to which a third embodiment is applied.

FIG. 9B is a view illustrating a damping force adjusting part to which a third embodiment is applied.

FIG. 10 is a view illustrating a damping force adjusting part according to a fourth embodiment.

FIG. 11 is a view illustrating a damping force adjusting part according to a fifth embodiment.

FIG. 12 is a view illustrating a damping force adjusting part according to a sixth embodiment.

### DETAILED DESCRIPTION OF THE INVENTION

Hereinafter, embodiments of the present invention will be described in detail with reference to the accompanying drawings.

### First Embodiment

[Configuration and Function of Hydraulic Shock Absorber 1]

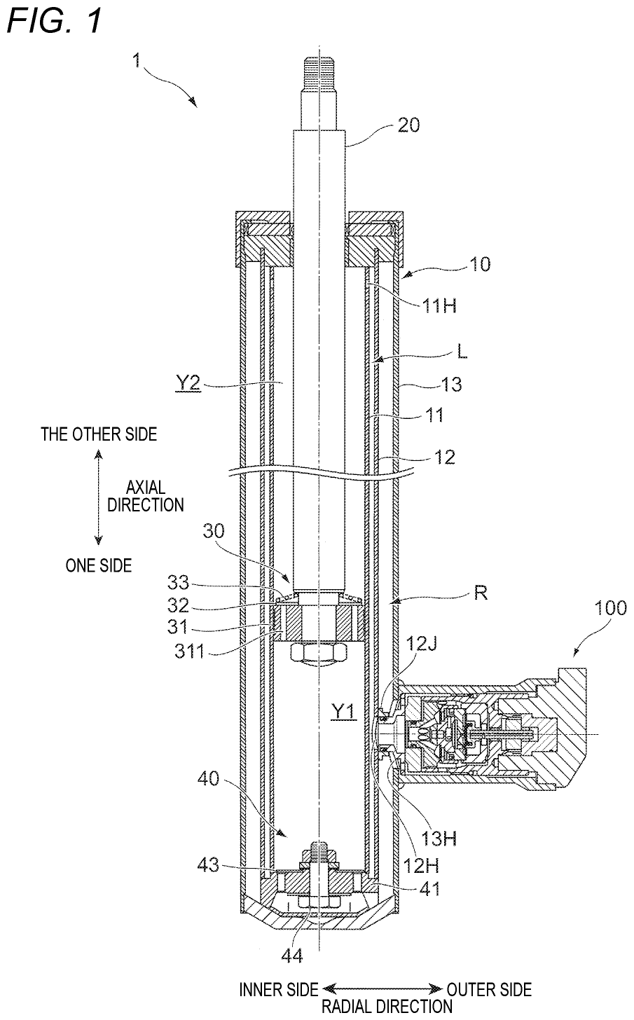

FIG. 1 is an overall view of a hydraulic shock absorber 1 according to a first embodiment.

As shown in FIG. 1, the hydraulic shock absorber 1 includes a cylinder part 10 that accommodates oil, and a rod 20 that is provided such that one side is slidably inserted into the cylinder part 10 and the other side protrudes from the cylinder part 10. Further, the hydraulic shock absorber 1 includes a piston part 30 provided at an end portion on the one side of the rod 20, and a bottom part 40 provided at an end portion on the one side of the cylinder part 10. Further, the hydraulic shock absorber 1 includes an outer damper 100 that is provided outside the cylinder part 10 and generates a damping force.

In the following description, a longitudinal direction of the cylinder part 10 shown in FIG. 1 is referred to as an “axial direction”. A lower side of the cylinder part 10 in the axial direction is referred to as “one side”, and an upper side of the cylinder part 10 is referred to as “the other side”.

A left-right direction of the cylinder part 10 shown in FIG. 1 is referred to as a “radial direction”. In the radial direction, a center axis side is referred to as a “radially inner side”, and a side away from a center axis is referred to as a “radially outer side”.

[Configuration and Function of Cylinder Part 10]

The cylinder part 10 includes a cylinder 11 that accommodates the oil, an outer cylinder body 12 that is provided on the radially outer side of the cylinder 11, and a damper case 13 that is provided on the radially outer side of the cylinder 11 and further on the radially outer side of the outer cylinder body 12.

The cylinder 11 is formed in a cylindrical shape, and has a cylinder opening 11H on the other side.

The outer cylinder body 12 is formed in a cylindrical shape. Further, a communication path L is formed between the outer cylinder body 12 and the cylinder 11. The outer cylinder body 12 includes an outer cylinder body opening portion 12H and an outer connection portion 12J at a position facing the outer damper 100. The outer connection portion 12J serves as a connection portion with the outer damper 100 defining a flow path of the oil and protruding toward the radially outer side.

The damper case 13 is formed in a cylindrical shape. Further, a reservoir chamber R for storing the oil is formed between the damper case 13 and the outer cylinder body 12. The reservoir chamber R absorbs the oil in the cylinder 11 or supplies the oil into the cylinder 11 along with a relative movement of the rod 20 with respect to the cylinder 11. Further, the reservoir chamber R stores the oil flowing out of the outer damper 100. The damper case 13 includes a case opening portion 13H at a position facing the outer damper 100.

[Configuration and Function of Rod 20]

The rod 20 is a rod-shaped member extending long in the axial direction. One side of the rod 20 is connected to the piston part 30. The other side of the rod 20 is connected to, for example, a vehicle body via a coupling member (not shown) or the like. The rod 20 may be either a hollow rod having a hollow inside or a solid rod having no hollow inside.

[Configuration and Function of piston part 30]

The piston part 30 includes a piston body 31 having a plurality of piston oil path ports 311, a piston valve 32 that opens and closes the other side of the piston oil path ports 311, and a spring 33 provided between the piston valve 32 and one side end portion of the rod 20. The piston part 30 partitions the oil in the cylinder 11 into a first oil chamber Y1 and a second oil chamber Y2.

[Configuration and Function of Bottom Part 40]

The bottom part 40 includes a valve seat 41, a check valve portion 43 provided on the other side of the valve seat 41, and a fixing member 44 provided in the axial direction. The bottom part 40 separates the first oil chamber Y1 and the reservoir chamber R.

[Configuration and Function of Outer Damper 100]

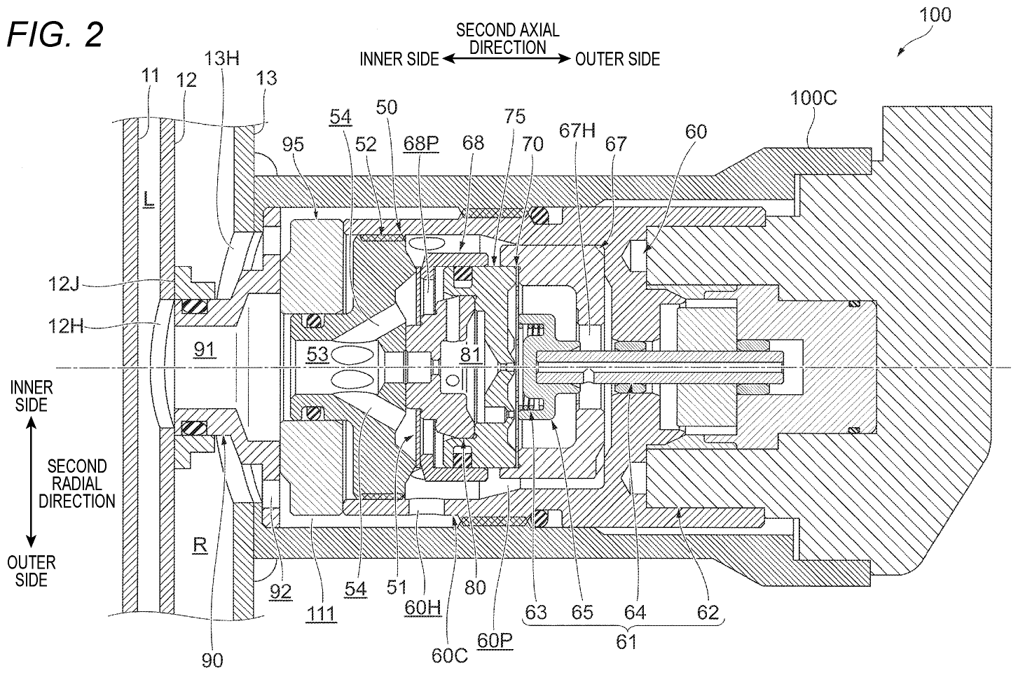

FIG. 2 is a cross-sectional view of the outer damper 100 according to the first embodiment.

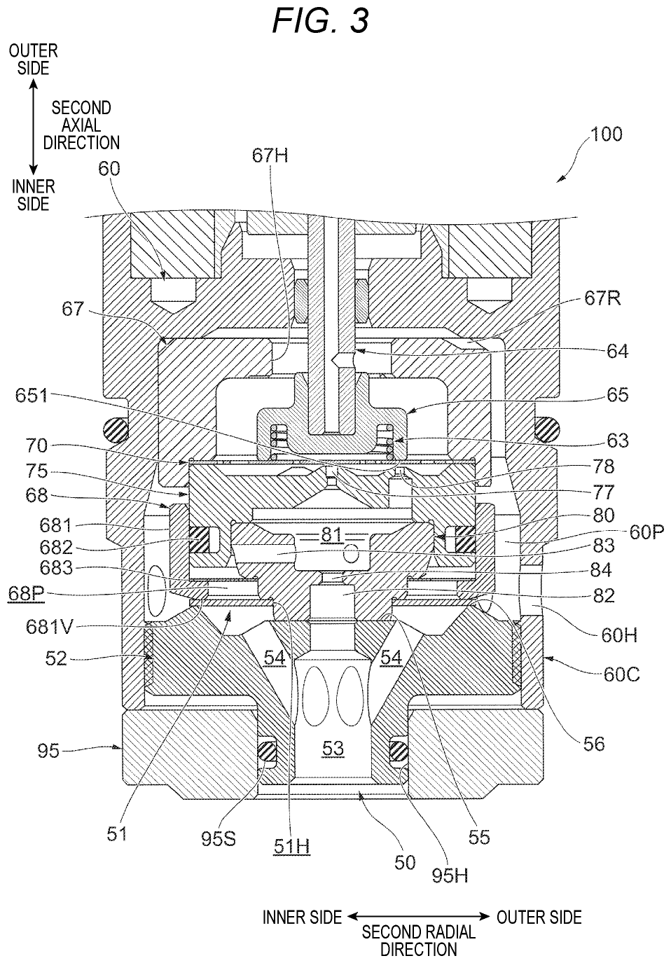

FIG. 3 is a partial cross-sectional view of a main valve part 50 and a damping force adjusting part 60 according to the first embodiment.

In the following description, a longitudinal direction of the outer damper 100 shown in FIG. 2 (that is, an intersecting direction (for example, a substantially orthogonal direction) intersecting the axial direction of the cylinder part 10 (see FIG. 1)) is referred to as a “second axial direction”. A left side of the outer damper 100 in the second axial direction is referred to as a “second axially inner side”, and a right side of the outer damper 100 in the second axial direction is referred to as a “second axially outer side”.

An up-lower direction of the outer damper 100 shown in FIG. 2 (that is, a direction intersecting the second axial direction) is referred to as a “second radial direction”. Then, in the second radial direction, a side toward a center axis extending along a second axis is referred to as a “second radially inner side”, and a side away from the center axis extending along the second axis is referred to as a “second radially outer side”.

As shown in FIG. 2, the outer damper 100 includes a main valve part 50 that mainly generates a damping force in the hydraulic shock absorber 1 of the first embodiment, and a damping force adjusting part 60 that adjusts magnitude of the damping force generated by the outer damper 100. The outer damper 100 includes a case 60C that holds the main valve part 50 and the damping force adjusting part 60. Further, the outer damper 100 includes a spacer 95 that supports the main valve part 50, and a connection flow path portion 90 that forms a flow path of the oil from the communication path L to the main valve part 50. Further, the outer damper 100 includes an outer housing 100C that accommodates various components constituting the outer damper 100.

(Main Valve Part 50)

The main valve part 50 includes a main valve 51 (an example of a first valve) that generates a damping force by performing control to restrict a flow of the oil, and a main valve seat 52 (an example of a first flow path forming portion) that faces the main valve 51 and is in contact with the main valve 51.

As shown in FIG. 3, the main valve 51 is a disc-shaped member that has an opening portion 51H on the second radially inner side and is elastically deformed. As a material of the main valve 51, for example, a metal such as iron can be used. A flow path member 80 to be described later passes through the opening portion 51H of the main valve 51. The main valve 51 is provided to face the main valve seat 52 on the second axially outer side.

A movement in position of the main valve 51 configured as described above in the second radial direction is restricted by the flow path member 80 to be described later. Further, a second radially inner side of the main valve 51 is restricted by the flow path member 80 from moving toward the second axially outer side. Meanwhile, a second radially outer side of the main valve 51 is movable in the second axial direction when being deformed. Further, the main valve 51 restricts the flows of oil in main flow paths 54, which will be described later, of the main valve seat 52 to generate a differential pressure, and thus a damping force is generated.

Next, the main valve seat 52 will be described.

As shown in FIG. 3, the main valve seat 52 includes a central flow path 53 provided on the second radially inner side, and the main flow paths 54 provided on the second radially outer side of the central flow path 53. In addition, the main valve seat 52 includes a recess portion 55 recessed on the second axially outer side of the central flow path 53, and a round portion 56 provided on the second radially outer side of the main flow paths 54.

Then, the main valve seat 52 comes into contact with the flow path member 80 to be described later at the recess portion 55. In addition, a part of the main valve seat 52 on the second axially inner side is inserted into the spacer 95.

The central flow path 53 is formed along the second axial direction and penetrates the main valve seat 52. The central flow path 53 communicates with the connection flow path portion 90 (see FIG. 2) on the second axially inner side thereof, and communicates with the flow path member 80 to be described later on the second axially outer side thereof.

The main flow paths 54 constitute parallel flow paths respectively with respect to an inner pilot flow path 77 and outer pilot flow paths 78, which will be described later, of a pilot valve seat 75. In addition, a plurality of main flow paths 54 of the first embodiment are provided. Each of the main flow paths 54 communicates with the central flow path 53 on the second axially inner side thereof. In addition, the second axially outer side of each main flow path 54 is positioned between the recess portion 55 and the round portion 56.

The round portion 56 is formed in an annular shape. Further, the round portion 56 protrudes toward a main valve 51 side and outward in the second axial than the recess portion 55. Further, the round portion 56 serves as a portion on which the main valve 51 is seated.

(Damping Force Adjusting Part 60)

As shown in FIG. 2, the damping force adjusting part 60 includes an advancing and retreating unit 61 that causes a pilot valve 70 to be described to advance and retreat with respect to the pilot valve seat 75, and a cap portion 67 that mainly covers the pilot valve 70. The damping force adjusting part 60 includes a back pressure generating mechanism 68 that changes ease of deformation of the main valve 51 according to a pressure of oil in a back pressure chamber 68P to be described later. The damping force adjusting part 60 includes the pilot valve seat 75 (an example of a second flow path forming member) including flow paths which communicate with the back pressure chamber 68P to be described later and in which flows of oil at a low speed are generated, and the pilot valve 70 (an example of a second valve) that controls the flows of oil in the flow paths of the pilot valve seat 75. Further, the damping force adjusting part 60 includes the flow path member 80 that forms a flow path of oil between the pilot valve seat 75 and the main valve seat 52.

—Advancing and Retreating Unit 61—

As shown in FIG. 2, the advancing and retreating unit 61 includes a solenoid portion 62 that causes a plunger 64, which will be described later, to advance and retreat using an electromagnet, a compression coil spring 63 provided between a pressing member 65 to be described later and the pilot valve 70, the plunger 64 that advances and retreats along the second axial direction, and the pressing member 65 that presses the pilot valve 70 against the pilot valve seat 75.

When the electromagnet is energized, the solenoid portion 62 pushes the plunger 64 toward the pressing member 65.

The compression coil spring 63 is in contact with the pilot valve 70 on the second axially inner side thereof, and is in contact with the pressing member 65 on the second axially outer side thereof. The compression coil spring 63 applies a force in a direction in which the pressing member 65 and the pilot valve 70 are separated from each other to the pressing member 65 and the pilot valve 70.

The plunger 64 is pushed out toward the pressing member 65 when the solenoid portion 62 is in the energized state, and is pushed back by the compression coil spring 63 when the solenoid portion 62 is in the non-energized state.

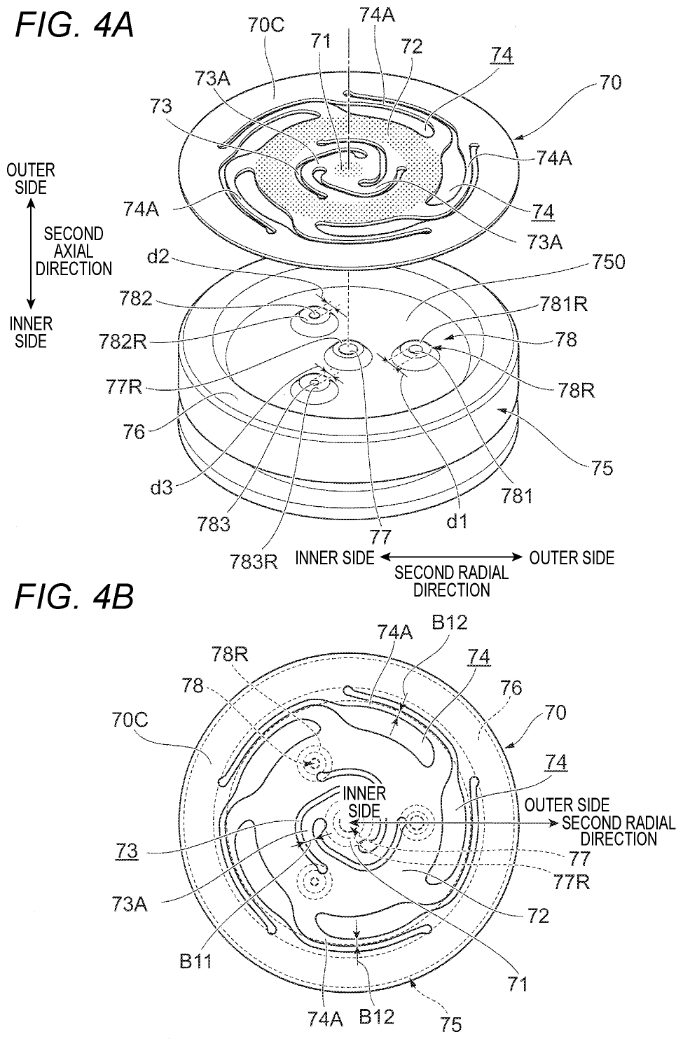

As shown in FIG. 3, the pressing member 65 includes a valve contact portion 651 that protrudes toward a pilot valve 70 side (that is, the second axially inner side). The valve contact portion 651 of the first embodiment is formed in an annular shape. Further, the valve contact portion 651 is formed at a position facing a second facing portion 72 (see FIGS. 4A and 4B to be described later) of the pilot valve 70. Further, the valve contact portion 651 is in contact with the second facing portion 72.

—Cap Portion 67—

As shown in FIG. 3, the cap portion 67 is a component having an opening portion 67H on the second axially outer side and having a substantially cylindrical shape. Further, the cap portion 67 is provided such that the plunger 64 penetrates the opening portion 67H. In addition, the cap portion 67 is provided such that the pressing member 65 advances and retreats along the second axial direction inside the cap portion 67.

As shown in FIG. 3, the cap portion 67 is fixed by being pressed against the case 60C. In addition, the cap portion 67 has a cap flow path 67R through which the oil flows between the cap portion 67 and the case 60C. The cap flow path 67R communicates with the opening portion 67H and also communicates with an in-case flow path 60P to be described later.

—Back Pressure Generating Mechanism 68—

As shown in FIG. 3, the back pressure generating mechanism 68 includes a spool 681 provided on an opposite side (that is, on the second axially outer side) of the main valve 51 with respect to the main valve seat 52. In addition, the back pressure generating mechanism 68 includes a seal member 682 that seals (that is, liquid-tightly) the pilot valve seat 75 and the spool 681. Further, the back pressure generating mechanism 68 includes a return spring 683 that applies a force for pressing the spool 681 against the main valve 51 to the spool 681.

The spool 681 is formed in a substantially cylindrical shape. The spool 681 is movable in the second axial direction. For example, when the main valve 51 is deformed toward the second axially outer side, the spool 681 moves toward second axially outer side. When the main valve 51 returns from the deformed state to an original state toward the second axially inner side, the spool 681 moves toward the second axially inner side.

The spool 681 of the first embodiment includes a main valve contact portion 681V that is in contact with the main valve 51. The main valve contact portion 681V is provided on the second axially inner side of the spool 681. The main valve contact portion 681V of the first embodiment is formed such that a width thereof gradually decreases from the second axially outer side toward the second axially inner side. The main valve contact portion 681V is in annular contact with the main valve 51. Further, the spool 681 is one of components that form the back pressure chamber 68P that applies an oil pressure (hereinafter, referred to as a back pressure) from the second axially outer side, which is an opposite side with respect to the main valve seat 52, to the main valve 51.

Here, the back pressure chamber 68P is a chamber into which oil flows to cause an oil pressure corresponding to the oil flowing into the back pressure chamber 68P to act on the main valve 51. The back pressure chamber 68P applies a force for pressing the main valve 51 against the main valve seat 52 to the main valve 51. That is, the back pressure chamber 68P applies the back pressure to the main valve 51. The back pressure chamber 68P of the first embodiment is formed by the spool 681, the pilot valve seat 75, and the flow path member 80.

The seal member 682 is formed in an annular shape. The seal member 682 may be made of an elastically deformable resin material such as engineered plastic or rubber.

FIGS. 4A and 4B are views illustrating the pilot valve 70 and the pilot valve seat 75 of the first embodiment.

FIG. 4A is a perspective view of the pilot valve 70 and the pilot valve seat 75, and FIG. 4B is a top view of the pilot valve 70.

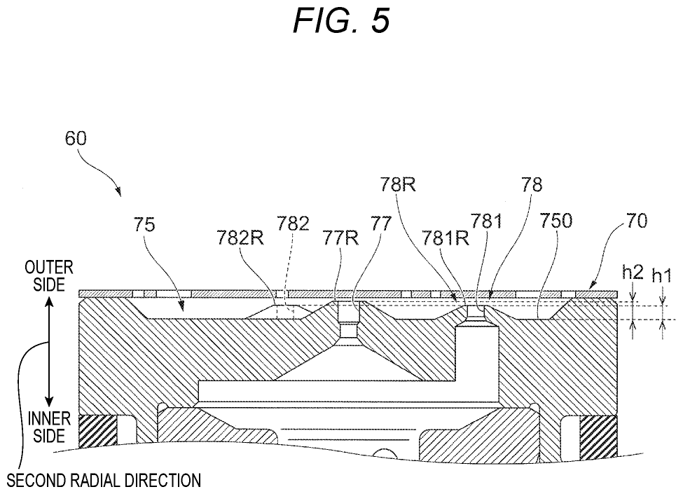

FIG. 5 is a view illustrating the pilot valve seat 75 of the first embodiment.

—Pilot Valve Seat 75—

As shown in FIG. 4A, the pilot valve seat 75 includes an outer seat portion 76 that supports the pilot valve 70, and the inner pilot flow path 77 and outer pilot flow paths 78 that constitute a flow path of oil for adjusting a pressure of the oil in the back pressure chamber 68P (see FIG. 3).

The outer seat portion 76 protrudes annularly toward the second axially outer side with respect to a bottom surface portion 750 which is a substantially circular surface provided on the second axially outer side. The outer seat portion 76 faces an outer annular portion 70C (to be described later) of the pilot valve 70. In addition, the outer seat portion 76 protrudes from the bottom surface portion 750 outward than the inner pilot flow path 77 and the outer pilot flow paths 78 in the second axial direction.

The inner pilot flow path 77 is provided on the second radially inner side of the pilot valve 70. Further, the inner pilot flow path 77 is provided to penetrate the pilot valve seat 75 in the second axial direction (see FIG. 3). In addition, the inner pilot flow path 77 includes an inner round 77R on the second axially outer side. The inner round 77R protrudes annularly toward the second axially outer side. Further, the inner round 77R serves as a contact portion with the pilot valve 70.

A plurality of outer pilot flow paths 78 are provided in the pilot valve seat 75 of the first embodiment. Specifically, the pilot valve seat 75 of the first embodiment includes a first outer pilot flow path 781, a second outer pilot flow path 782, and a third outer pilot flow path 783. In the following description, the first outer pilot flow path 781, the second outer pilot flow path 782, and the third outer pilot flow path 783 are collectively referred to as outer pilot flow paths 78 when not being particularly distinguished from one another.

Further, the plurality of outer pilot flow paths 78 are disposed on the second radially outer side of the inner pilot flow path 77 so as to surround the inner pilot flow path 77. Further, each of the outer pilot flow paths 78 is provided to penetrate the pilot valve seat 75 in the second axial direction (see FIG. 3).

In addition, each of the outer pilot flow path 78 has an outer round 78R on the second axially outer side. The outer round 78R protrudes annularly toward the second axially outer side. Further, the outer round 78R serves as a contact portion with the pilot valve 70.

In the following description, the outer round 78R of the first outer pilot flow path 781 is referred to as a first outer round 781R. The outer round 78R of the second outer pilot flow path 782 is referred to as a second outer round 782R. The outer round 78R of the third outer pilot flow path 783 is referred to as a third outer round 783R.

As shown in FIG. 5, in the plurality of outer pilot flow paths 78, heights of the outer rounds 78R are substantially equal to one another when the bottom surface portion 750 is used as a reference. That is, each of the first outer round 781R, the second outer round 782R, and the third outer round 783R has a height h1.

The height h1 of the outer round 78R of each of the plurality of outer pilot flow paths 78 is smaller than a height h2 of the inner round 77R of the inner pilot flow path 77.

Further, in the pilot valve seat 75 of the first embodiment, inner diameters of flow path ports of the plurality of outer pilot flow paths 78 are different from one another. That is, the plurality of outer pilot flow paths 78 are different from one another in flow path cross-sectional area of the flow path port. Specifically, as shown in FIG. 4A, an inner diameter d1 of the flow path port of the first outer pilot flow path 781 is larger than an inner diameter d2 of the flow path port of the second outer pilot flow path 782 and an inner diameter d3 of the flow path port of the third outer pilot flow path 783. Further, the inner diameter d2 of the flow path port of the second outer pilot flow path 782 is larger than the inner diameter d3 of the flow path port of the third outer pilot flow path 783. That is, the flow path cross-sectional areas of the flow path ports of the plurality of outer pilot flow paths 78 increase in order of the third outer pilot flow path 783, the second outer pilot flow path 782, and the first outer pilot flow path 781.

The flow path cross-sectional area of the flow path port of each outer pilot flow path 78 is smaller than a flow path cross-sectional area of the flow path port of the inner pilot flow path 77.

—Pilot Valve 70—

As shown in FIG. 4A, the pilot valve 70 is an elastically deformable member having a substantially circular plate shape. As a material of the pilot valve 70, for example, a metal such as iron can be used. Further, the pilot valve 70 is provided to face the second axially outer side of the pilot valve seat 75.

Further, the pilot valve 70 of the first embodiment controls flows of oil in the inner pilot flow path 77 and the outer pilot flow paths 78 which are flow paths parallel to the main flow path 54 (see FIG. 3) of the main valve part 50 and different from the main flow path 54.

The pilot valve 70 includes the outer annular portion 70C formed in an annular shape, a first facing portion 71 facing the inner pilot flow path 77, and the second facing portion 72 facing the outer pilot flow paths 78. Further, the pilot valve 70 includes inner opening portions 73 provided on the second radially inner side and facilitating deformation of the pilot valve 70 in the second axial direction, and outer opening portions 74 provided outward than the inner opening portions 73 in the second radial direction and facilitating deformation of the pilot valve 70 in the second axial direction.

The outer annular portion 70C is provided on the second radially outer side. The outer annular portion 70C functions as a portion sandwiched between the cap portion 67 and the pilot valve seat 75. Further, the pilot valve 70 is held by the pilot valve seat 75 when the outer annular portion 70C is sandwiched (see FIG. 3).

The first facing portion 71 has a circular shape and is formed in a plate shape. The first facing portion 71 is formed to be larger than the inner diameter of the inner pilot flow path 77, and can cover the inner round 77R. In the first embodiment, the first facing portion 71 is formed at a central portion (that is, the second radially inner side) of the pilot valve 70.

The second facing portion 72 has an annular shape and is formed in a plate shape. The second facing portion 72 is formed to be larger than the inner diameter of the outer pilot flow path 78, and can cover the outer round 78R. The second facing portion 72 is formed outward than the first facing portion 71 in the second radial direction. The second facing portion 72 is formed as an annular region in the pilot valve 70. Thus, in the first embodiment, regardless of a circumferential position on the pilot valve 70 with respect to the pilot valve seat 75, the second facing portion 72 always faces the outer pilot flow paths 78.

The inner opening portion 73 extends long along a circumferential direction of the pilot valve 70. In addition, a plurality of inner opening portions 73 are provided. An inner arm portion 73A is formed between two adjacent inner opening portions 73. Each of the inner arm portions 73A is formed such that at least a part thereof extends along the circumferential direction. In the first embodiment, the plurality of inner arm portions 73A are formed in a spiral shape as a whole. In the pilot valve 70, the inner arm portions 73A are provided outward than the first facing portion 71 in the second radial direction and inward than the second facing portion 72 in the second radial direction. That is, the inner arm portions 73A are provided between the first facing portion 71 and the second facing portion 72 in the second radial direction.

As shown in FIG. 4B, in the pilot valve 70 of the first embodiment, the plurality of inner arm portions 73A are formed such that widths B11 of central portions of the inner arm portions 73A are substantially equal to one another.

As shown in FIG. 4A, the outer opening portion 74 extends in the circumferential direction of the pilot valve 70. In addition, a plurality of outer opening portions 74 are provided, and are arranged at substantially equal intervals in the circumferential direction. Further, in the pilot valve 70 of the first embodiment, two different outer opening portions 74 are disposed so as to overlap each other in the second radial direction.

Further, as shown in FIG. 4B, the outer opening portions 74 are formed outward than the second facing portion 72 in the second radial direction and inward than the outer annular portion 70C in the second radial direction.

Further, an outer arm portion 74A is formed between two adjacent outer opening portions 74. Each of the outer arm portions 74A is formed such that at least a part thereof extends along the circumferential direction. In the first embodiment, the plurality of outer arm portions 74A are formed in a spiral shape as a whole. Further, in the pilot valve 70, the outer arm portions 74A are provided outward than the second facing portion 72 in the second radial direction and inward than the outer annular portion 70C in the second radial direction. That is, the outer arm portions 74A are provided between the second facing portion 72 and the outer annular portion 70C in the second radial direction.

As shown in FIG. 4B, in the pilot valve 70 of the first embodiment, the plurality of outer arm portions 74A are formed such that widths B12 of central portions of the outer arm portions 74A are substantially equal to one another.

In the pilot valve 70 of the first embodiment, rigidity at locations where the inner arm portions 73A and the outer arm portions 74A are formed is reduced, and the pilot valve 70 is easily deformed at the locations where the inner arm portions 73A and the outer arm portions 74A are formed. In particular, in the first embodiment, for example, each of the inner arm portion 73A and the outer arm portion 74A is formed to extend along the circumferential direction, so as to secure a length of a deformable arm, and thus is more easily deformed.

—Flow Path Member 80—

As shown in FIG. 3, the flow path member 80 includes a communication chamber 81 that communicates with the inner pilot flow path 77 and the outer pilot flow paths 78, a central communication path 82 that communicates with the communication chamber 81 and the central flow path 53 of the main valve seat 52, and a back pressure communication path 83 that connects the communication chamber 81 and the back pressure chamber 68P.

The communication chamber 81 communicates with the central communication path 82 on the second axially inner side thereof, and communicates with the inner pilot flow path 77 and the outer pilot flow paths 78 on the second axially outer side thereof.

The central communication path 82 communicates with the central flow path 53 on the second axially inner side thereof, and communicates with the communication chamber 81 on the second axially outer side thereof. The central communication path 82 has an orifice flow path 84 for restricting the flow of the oil. The orifice flow path 84 is formed such that a flow path cross-sectional area of the oil is smaller than that of the back pressure communication path 83. The orifice flow path 84 makes it difficult for the oil in the back pressure chamber 68P to return to the central flow path 53.

The back pressure communication path 83 communicates with the communication chamber 81 on the second radially inner side thereof, and communicates with the back pressure chamber 68P on second radially outer side thereof.

(Case 60C)

As shown in FIG. 2, the case 60C supports, on the second axially outer side thereof, the plunger 64 so as to be movable in the second axial direction. The case 60C includes the in-case flow path 60P through which oil flows in the case 60C, and a through hole 60H penetrating the case 60C.

The oil flowing out from the opening portion 67H of the cap portion 67 and the oil flowing out from the main flow paths 54 opened in the main valve 51 flows into the in-case flow path 60P.

The through hole 60H communicates with the in-case flow path 60P and an in-housing flow path 111 to be described later.

(Connection Flow Path Portion 90)

As shown in FIG. 2, the connection flow path portion 90 includes an inner flow path 91 provided on the second radially inner side and outer flow paths 92 provided on the second radially outer side.

The inner flow path 91 communicates with the outer cylinder body opening portion 12H on the second axially inner side thereof, and communicates with the central flow path 53 of the main valve seat 52 on the second axially outer side thereof.

A plurality of outer flow paths 92 are provided. The outer flow paths 92 communicate with the case opening portion 13H on the second axially inner side thereof, and communicate with the in-housing flow path 111, which will be described later, on the second axially outer side thereof.

(Spacer 95)

As shown in FIG. 3, the spacer 95 is a disc-shaped member having an opening portion 95H on the second radially inner side thereof. The spacer 95 includes a seal member 95S provided between the spacer 95 and the main valve seat 52. As shown in FIG. 2, the main valve seat 52 is inserted into the spacer 95 from the second axially outer side, and faces the connection flow path portion 90 on the second axially inner side thereof.

(Outer Housing 100C)

As shown in FIG. 2, the outer housing 100C is a substantially cylindrical member. The outer housing 100C is fixed to the damper case 13 on the second axially inner side thereof by, for example, welding or the like.

In the outer housing 100C, the in-housing flow path 111, which is a flow path of oil in the outer housing 100C, is formed on the second radially outer side of the case 60C.

[Operation of Hydraulic Shock Absorber 1]

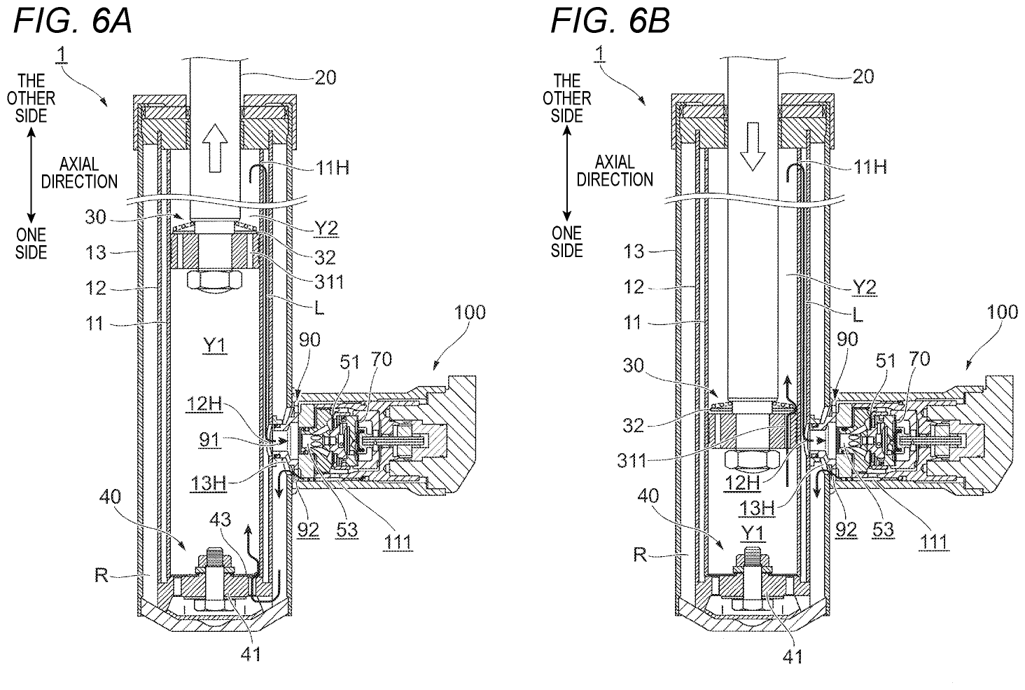

FIGS. 6A and 6B are views illustrating an operation of the hydraulic shock absorber 1 of the first embodiment.

FIG. 6A shows a flow of oil during a rebound stroke, and FIG. 6B shows a flow of oil during a compression stroke.

First, an operation of the hydraulic shock absorber 1 during the rebound stroke will be described.

As shown in FIG. 6A, during the rebound stroke, the rod 20 moves to the other side with respect to the cylinder 11. At this time, the piston valve 32 keeps blocking the piston oil path ports 311. In addition, a volume of the second oil chamber Y2 decreases due to the movement of the piston part 30 to the other side. Then, the oil in the second oil chamber Y2 flows out from the cylinder opening 11H to the communication path L.

Further, the oil flows into the outer damper 100 through the communication path L and the outer cylinder body opening portion 12H. Then, in the outer damper 100, the oil first flows into the inner flow path 91 of the connection flow path portion 90. Thereafter, in the outer damper 100, a damping force is generated in the main valve 51 or the pilot valve 70. The flow of oil at this time will be described in detail later.

Thereafter, the oil flowing to the main valve 51 or the pilot valve 70 flows to the in-housing flow path 111. Further, the oil flows into the reservoir chamber R from the case opening portion 13H through the outer flow path 92 of the connection flow path portion 90.

The pressure in the first oil chamber Y1 is relatively lower than that in the reservoir chamber R. Therefore, the oil in the reservoir chamber R flows into the first oil chamber Y1 through the bottom part 40.

Next, an operation of the hydraulic shock absorber 1 during the compression stroke will be described.

As shown in FIG. 6B, during the compression stroke, the rod 20 moves relative to the cylinder 11 to the one side. In the piston part 30, the piston valve 32 blocking the piston oil path ports 311 is opened due to a differential pressure between the first oil chamber Y1 and the second oil chamber Y2. Then, the oil in the first oil chamber Y1 flows out to the second oil chamber Y2 through the piston oil path ports 311. Here, the rod 20 is disposed in the second oil chamber Y2. Therefore, an amount of oil flowing from the first oil chamber Y1 into the second oil chamber Y2 is excessive by a volume of the rod 20. Therefore, the amount of oil corresponding to the volume of the rod 20 flows out from the cylinder opening 11H to the communication path L.

Further, the oil flows into the outer damper 100 through the communication path L and the outer cylinder body opening portion 12H. A flow of the oil in the outer damper 100 is the same as the flow of oil in the rebound stroke described above. That is, in the hydraulic shock absorber 1 of the first embodiment, a direction in which the oil flows in the outer damper 100 is the same in both the compression stroke and the rebound stroke.

As described above, in the hydraulic shock absorber 1 of the first embodiment, the damping force is generated in the outer damper 100 in both the compression stroke and the rebound stroke.

Next, the flow of oil in the outer damper 100 of the first embodiment will be described in detail.

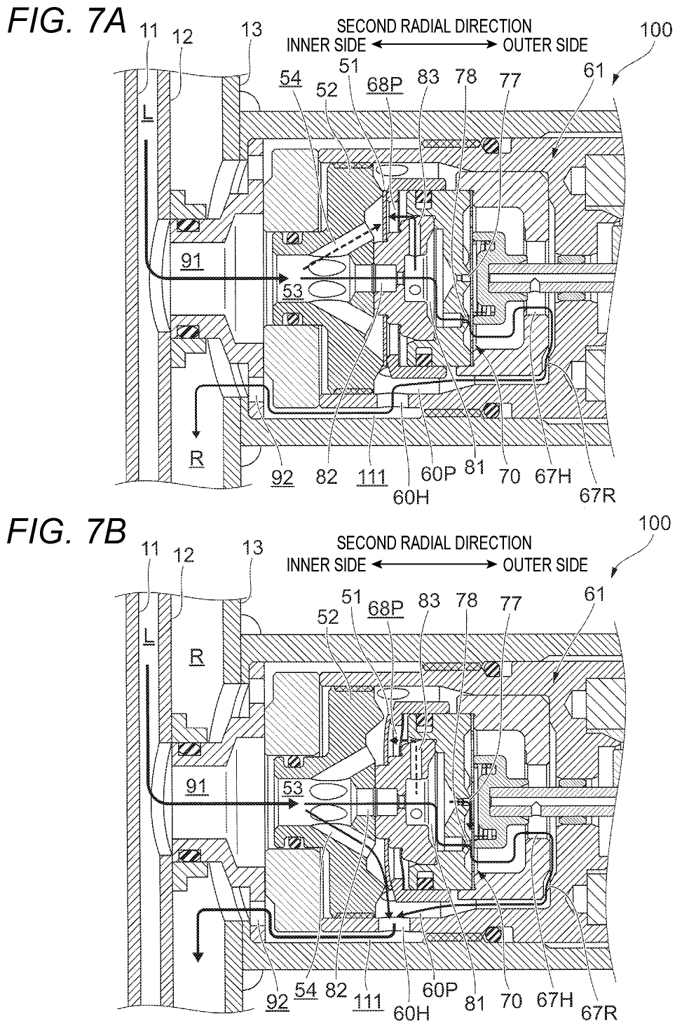

FIGS. 7A and 7B are views illustrating flows of the oil in the outer damper 100 of the first embodiment.

FIG. 7A shows a flow of oil at a low speed when a moving speed of the piston part 30 is relatively low, and FIG. 7B shows a flow of oil at a high speed when the moving speed of the piston part 30 is relatively high.

(At Low Speed)

As shown in FIG. 7A, when the moving speed of the piston part 30 (see FIG. 1) is low, the oil flowing into the inner flow path 91 flows into the central flow path 53.

The oil flowing into the central flow path 53 flows into the communication chamber 81 from the central communication path 82. The oil in the communication chamber 81 flows into the back pressure chamber 68P through the back pressure communication path 83.

Here, as to be described later, the oil in the communication chamber 81 flows out through the outer pilot flow paths 78 while opening the pilot valve 70. However, a flow rate of the oil flowing through the outer pilot flow path 78 is relatively small. A protrusion height of the inner pilot flow path 77 is higher than that of the outer pilot flow path 78. Therefore, even when the oil flowing to the outer pilot flow path 78 flows while opening the pilot valve 70, the pilot valve 70 keeps the inner pilot flow path 77 closed. Therefore, a pressure of the oil in the back pressure chamber 68P connected to the communication chamber 81 is relatively high. When the pressure of the oil in the back pressure chamber 68P is high, the main valve 51 is pressed toward the main valve seat 52.

As described above, when the moving speed of the piston part 30 is low, there is no flow of oil that opens the main valve 51 in the main flow path 54.

Then, the oil in the communication chamber 81 flows to the plurality of outer pilot flow paths 78. Then, the oil flowing into the outer pilot flow path 78 flows through a gap between the outer round 78R and the pilot valve 70 while deforming the pilot valve 70 in a direction away from the pilot valve seat 75. In this way, in the damping force adjusting part 60 of the first embodiment, the plurality of outer pilot flow paths 78 function as flow paths of oil at a low speed.

In addition, the pilot valve 70 is deformed more easily at a portion where a pressure receiving area is large. Therefore, the oil flowing through the outer pilot flow paths 78 flows out while opening the pilot valve 70 with a time difference in the order of the first outer pilot flow path 781, the second outer pilot flow path 782, and the third outer pilot flow path 783 (see FIG. 4A and FIG. 4B).

Then, the oil flowing out from the outer pilot flow path 78 flows through the opening portion 67H, the cap flow path 67R, the in-case flow path 60P, the through hole 60H, the in-housing flow path 111, and the outer flow path 92 in this order, and flows out to the reservoir chamber R. When the moving speed of the piston part 30 is low and a flow rate of the oil flowing through the communication chamber 81 is small, the damping force is generated by a differential pressure due to the flow rate of the oil being reduced by the gap between the outer round 78R of the outer pilot flow path 78 and the pilot valve 70. Further, in the first embodiment, the oil flows while opening the pilot valve 70 with a time difference in the plurality of outer pilot flow paths 78. Accordingly, in the outer damper 100 of the first embodiment, an amount of change in the opening area of the outer pilot flow path 78 caused by the pilot valve 70 and corresponding to the flow rate of the oil is small.

(At High Speed)

As shown in FIG. 7B, when the moving speed of the piston part 30 (see FIG. 1) is high, the oil flowing into the inner flow path 91 flows into the central flow path 53.

The oil flowing into the central flow path 53 flows into the communication chamber 81 from the central communication path 82. The oil in the communication chamber 81 flows into the back pressure chamber 68P through the back pressure communication path 83. Here, when the moving speed of the piston part 30 is relatively high, a flow rate of the oil flowing through the communication chamber 81 is relatively large. Then, the oil flowing into the communication chamber 81 opens the pilot valve 70, and flows out from the inner pilot flow path 77 in addition to the outer pilot flow paths 78. Therefore, the oil pressure in the back pressure chamber 68P is lower than that in a state where the pilot valve 70 closes the inner pilot flow path 77.

Then, the oil flowing into the main flow path 54 opens the main valve 51 and flows out between the main valve 51 and the round portion 56 (see FIG. 3) of the main valve seat 52. The flow rate of the oil is reduced by a gap between the round portion 56 and the main valve 51, thereby generating a differential pressure. Further, the oil flows through the in-case flow path 60P, the through hole 60H, the in-housing flow path 111, and the outer flow path 92, and flows into the reservoir chamber R.

When the moving speed is high, the oil flowing into the central flow path 53 also flows into the reservoir chamber R while generating the differential pressure due to the flow rate being reduced by the gap between the outer round 78R of the outer pilot flow path 78 and the pilot valve 70, as in the case of the low speed.

As described above, when the moving speed of the piston part 30 is high, the damping force is generated mainly by the flows of oil in the main flow paths 54 of the main valve seat 52.

[Adjustment Operation of Damping Force Adjusting Part 60]

Next, an adjustment operation in the damping force adjusting part 60 will be described.

As shown in FIG. 2, the pilot valve 70 is pressed against the pilot valve seat 75 by pushing the pressing member 65 toward the second axially inner side. Further, a pressing force of the pressing member 65 changes according to an amount of current flowing through the solenoid portion 62 (see FIG. 2). Therefore, the damping force adjusting part 60 can set the damping force to any value within a range in which the pressing force of the pressing member 65 can be adjusted according to the amount of current flowing to the solenoid portion 62.

In the hydraulic shock absorber 1 of the first embodiment, the damping force is adjusted by operating the pressing member 65. That is, in the hydraulic shock absorber 1 of the first embodiment, a flow path area of the inner pilot flow path 77 and an opening degree of the pilot valve 70 with respect to the outer pilot flow path 78 are adjusted by changing the pressing force of the pilot valve 70 on the pilot valve seat 75 by the pressing member 65. Then, in the hydraulic shock absorber 1 of the first embodiment, the flow of oil in the inner pilot flow path 77 and the flow of oil in the outer pilot flow path 78 can be simultaneously controlled by the single pilot valve 70.

Here, in a general valve in the related art, an amount of change in opening area with respect to a flow rate increases as the opening degree with respect to the flow path decreases, and the amount of change in opening area with respect to the flow rate decreases as the opening degree with respect to the flow path increases. Therefore, it is difficult to adjust a pressing force applied to the valve by the pressing member 65, which is determined according to the amount of current flowing through the solenoid portion 62.

Meanwhile, in the damping force adjusting part 60 of the first embodiment, an amount of change in opening area of the outer pilot flow path 78 caused by the pilot valve 70 and corresponding to the flow rate of the oil is small. In the damping force adjusting part 60 of the first embodiment, a relationship between the pressing force applied to the pilot valve 70 by the pressing member 65 and an opening area of the outer pilot flow path 78 changed by the pilot valve 70 is nonlinear.

Thus, in the damping force adjusting part 60 of the first embodiment, the plurality of outer pilot flow paths 78 are provided, and thus control operations that the pilot valve 70 performs on the plurality of outer pilot flow paths 78 are different for each outer pilot flow path 78.

In the damping force adjusting part 60 of the first embodiment, the control that the pilot valve 70 performs on the flow of oil in the outer pilot flow path 78 can be more finely performed particularly in a state where the opening degree of the pilot valve 70 is small.

### Second Embodiment

Next, the hydraulic shock absorber 1 to which a second embodiment is applied will be described.

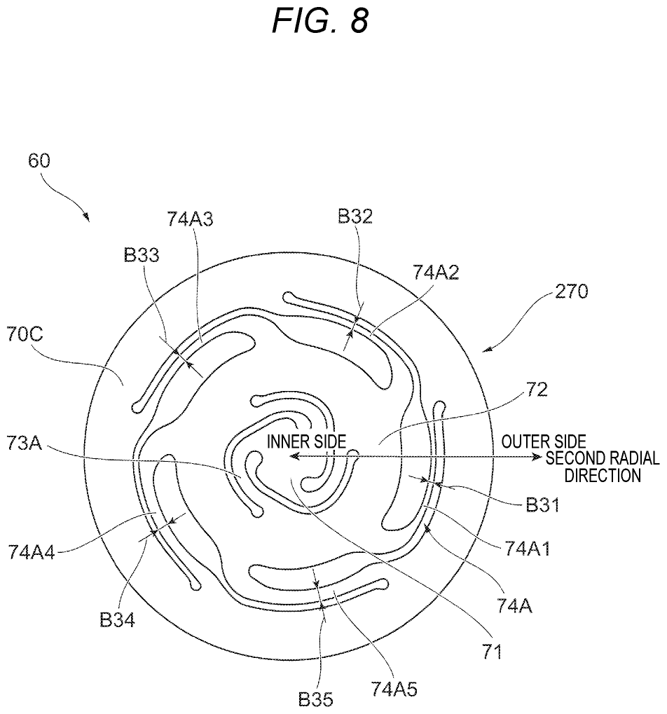

FIG. 8 is a view illustrating the damping force adjusting part 60 to which the second embodiment is applied.

In the description of the second embodiment, the same components as those of the other embodiments are denoted by the same reference numerals, and a detailed description thereof will be omitted.

Here, in the damping force adjusting part 60 of the second embodiment, in the pilot valve seat 75 (see FIGS. 4A and 4B), flow path cross-sectional areas of flow path ports of the plurality of outer pilot flow paths 78 are equal to one another. In the damping force adjusting part 60 to which the second embodiment is applied, a structure of a pilot valve 270 is different from that of the pilot valve 70 of the first embodiment.

As shown in FIG. 8, in the pilot valve 270 of the second embodiment, shapes of a plurality of outer arm portions 74A are different from one another. Specifically, the pilot valve 270 includes a first outer arm portion 74A1, a second outer arm portion 74A2, a third outer arm portion 74A3, a fourth outer arm portion 74A4, and a fifth outer arm portion 74A5. The pilot valve 270 is formed such that a width B31 of the first outer arm portion 74A1, a width B32 of the second outer arm portion 74A2, a width B33 of the third outer arm portion 74A3, a width B34 of the fourth outer arm portion 74A4, and a width B35 of the fifth outer arm portion 74A5 increase in this order.

In the pilot valve 270, the first outer arm portion 74A1, the second outer arm portion 74A2, the third outer arm portion 74A3, the fourth outer arm portion 74A4, and the fifth outer arm portion 74A5 have different rigidities, and thus spring coefficients of the respective outer arm portions 74A are different. That is, the pilot valve 270 has different spring coefficients in a circumferential direction.

In the pilot valve 270 of the second embodiment configured as described above, ease of deformation of the second facing portion 72 due to the oil flowing through the outer pilot flow paths 78 differs depending on a region to which a respective one of the outer arm portions 74A is connected. That is, in the second facing portion 72 of the pilot valve 270, a region to which the outer arm portion 74A having a relatively small width is connected is deformed easily, and a region to which the outer arm portion 74A having a relatively large width is connected is not deformed easily.

Therefore, the oil flowing through the outer pilot flow paths 78 flows in order, first flows out from the outer pilot flow path 78 facing the second facing portion 72 in a region to which the outer arm portion 74A having a smaller width is connected, and then flows out from the outer pilot flow path 78 facing the second facing portion 72 in a region to which the outer arm portion 74A having a larger width is connected.

As described above, in the damping force adjusting part 60 of the second embodiment, the oil flows while opening the pilot valve 270 with a time difference in the plurality of outer pilot flow paths 78. In the damping force adjusting part 60 of the second embodiment, an amount of change in opening area of the outer pilot flow path 78 caused by the pilot valve 270 and corresponding to the flow rate of the oil is small. Accordingly, in the damping force adjusting part 60 of the second embodiment, it is easy to control the flows of oil in the outer pilot flow paths 78 by the pilot valve 270 particularly in a state where the opening degree of the pilot valve 270 is small.

In the damping force adjusting part 60 of the second embodiment, thickness of the outer arm portion 74A may be different for each of the plurality of outer arm portions 74A. In the second embodiment, a length of the outer arm portion 74A may be different for each of the plurality of outer arm portions 74A. Similarly to the outer arm portion 74A, a plurality of inner arm portions 73A may have different widths, thicknesses, and lengths for each of the inner arm portions 73A.

### Third Embodiment

Next, the hydraulic shock absorber 1 to which a third embodiment is applied will be described.

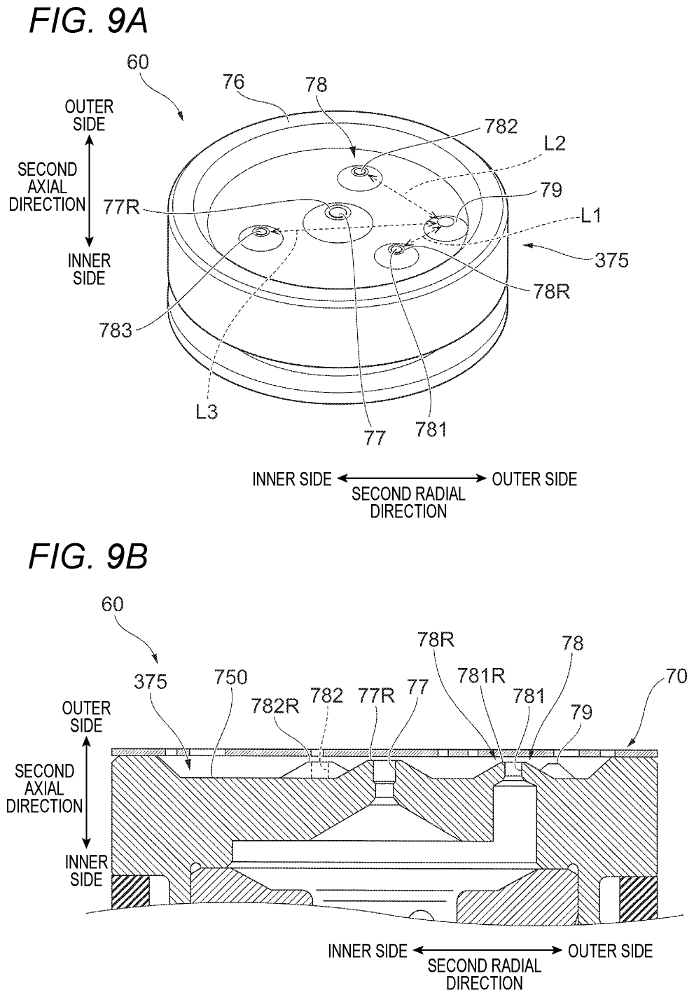

FIGS. 9A and 9B are views illustrating the damping force adjusting part 60 to which the third embodiment is applied.

FIG. 9A is a perspective view of a pilot valve seat 375, and FIG. 9B is a cross-sectional view of the pilot valve seat 375.

In the description of the third embodiment, the same components as those of the other embodiments are denoted by the same reference numerals, and a detailed description thereof will be omitted.

Here, in the damping force adjusting part 60 of the third embodiment, flow path cross-sectional areas of flow path ports of the plurality of outer pilot flow paths 78 are equal to one another. In the damping force adjusting part 60 to which the third embodiment is applied, a structure of the pilot valve seat 375 is different from that of the pilot valve seat 75 of the first embodiment.

As shown in FIG. 9A, the pilot valve seat 375 includes the outer seat portion 76, the inner pilot flow path 77, the outer pilot flow paths 78, and a protrusion portion 79 protruding toward the second axially outer side.

The protrusion portion 79 is disposed closest to any one of the outer pilot flow paths 78 among the plurality of outer pilot flow paths 78. In the third embodiment, a distance L1 between the protrusion portion 79 and the first outer pilot flow path 781 is shorter than a distance L2 between the protrusion portion 79 and the second outer pilot flow path 782 and a distance L3 between the protrusion portion 79 and the third outer pilot flow path 783. Further, the distance L2 between the protrusion portion 79 and the second outer pilot flow path 782 is shorter than the distance L3 between the protrusion portion 79 and the third outer pilot flow path 783.

In addition, as shown in FIG. 9B, the protrusion portion 79 is formed such that a protrusion height thereof from the bottom surface portion 750 of the pilot valve seat 375 is equal to or slightly smaller than the outer round 78R of the outer pilot flow path 78.

In the pilot valve 70 of the third embodiment configured as described above, ease of deformation of the second facing portion 72 due to the oil flowing through the outer pilot flow path 78 differs depending on the distance between the outer pilot flow path 78 and the protrusion portion 79. For example, in the pilot valve 70, the second facing portion 72 is relatively high in rigidity at a region where the distance between outer pilot flow path 78 and the protrusion portion 79 is short, and is not deformed easily. On the other hand, in the pilot valve 70, the second facing portion 72 is relatively low in rigidity at a region where the distance between the outer pilot flow path 78 and the protrusion portion 79 is long, and is deformed easily.

Therefore, the oil flowing through the outer pilot flow paths 78 first flows out from the outer pilot flow path 78 that is far from the protrusion portion 79 to open the pilot valve 70, and then flows out from the outer pilot flow path 78 that is close to the protrusion portion 79 to open the pilot valve 70.

As described above, in the damping force adjusting part 60 of the third embodiment, the oil flows while opening the pilot valve 70 with a time difference in the plurality of outer pilot flow paths 78. In the damping force adjusting part 60 of the third embodiment, an amount of change in opening area of the outer pilot flow path 78 caused by the pilot valve 70 and corresponding to the flow rate of the oil is small. Accordingly, in the damping force adjusting part 60 of the third embodiment, it is easy to control the flows of oil in the outer pilot flow paths 78 by the pilot valve 70 particularly in a state where the opening degree of the pilot valve 70 is small.

In the third embodiment, an example in which a single protrusion portion 79 is provided on the pilot valve seat 375 is shown, but a plurality of protrusion portions 79 may be provided.

### Fourth Embodiment

Next, the hydraulic shock absorber 1 to which a fourth embodiment is applied will be described.

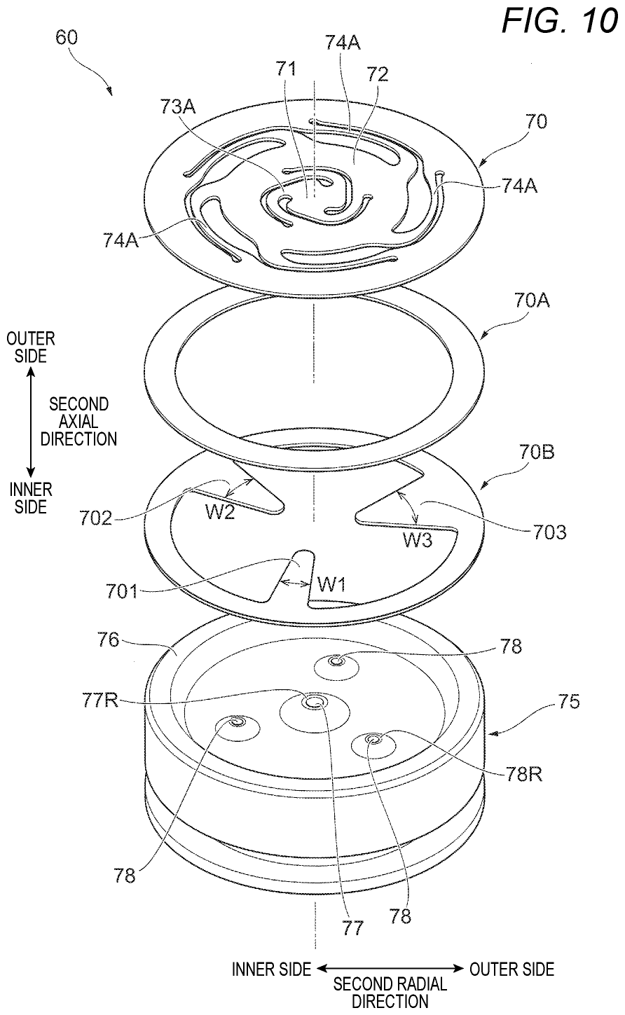

FIG. 10 is a view illustrating the damping force adjusting part 60 according to the fourth embodiment. In the description of the fourth embodiment, the same components as those of the other embodiments are denoted by the same reference numerals, and a detailed description thereof will be omitted.

As shown in FIG. 10, in the damping force adjusting part 60 of the fourth embodiment, in the pilot valve seat 75, flow path cross-sectional areas of flow path ports of the plurality of outer pilot flow paths 78 are equal to one another. The damping force adjusting part 60 of the fourth embodiment includes the pilot valve 70, a first spring 70A, and a second spring 70B.

The first spring 70A is an elastic member formed in an annular shape. The first spring 70A is provided to overlap the pilot valve 70 on the second axially inner side of the pilot valve 70.

The second spring 70B is an elastic member formed in an annular shape, and includes a first arm portion 701, a second arm portion 702, and a third arm portion 703 that protrude toward the second radially inner side. The first arm portion 701, the second arm portion 702, and the third arm portion 703 have different widths in a circumferential direction. Specifically, a width W1 of the first arm portion 701, a width W2 of the second arm portion 702, and a width W3 of the third arm portion 703 increase in this order.

The second spring 70B is provided to overlap the first spring 70A on the second axially inner side of the first spring 70A. The first arm portion 701, the second arm portion 702, and the third arm portion 703 are provided at positions that do not overlap the inner pilot flow path 77 and the outer pilot flow paths 78 in the second axial direction.

In the pilot valve 70 of the fourth embodiment configured as described above, ease of deformation of the second facing portion 72 due to the oil flowing through the outer pilot flow paths 78 differs depending on a positional relationship with each arm portion of the second spring 70B. That is, the second facing portion 72 of the pilot valve 70 is deformed easily at a region close to an arm portion having a relatively small width, and is not deformed easily at a region close to an arm portion having a relatively large width.

Therefore, the oil flowing through the outer pilot flow paths 78 flows in order, first flows out from the outer pilot flow path 78 facing the second facing portion 72 in a region close to the arm portion having a smaller width, and then flows out from the outer pilot flow path 78 facing the second facing portion 72 close to the arm portion having a larger width.

As described above, in the damping force adjusting part 60 of the fourth embodiment, the oil flows while opening the pilot valve 70 with a time difference in the plurality of outer pilot flow paths 78. In the damping force adjusting part 60 of the fourth embodiment, an amount of change in opening area of the outer pilot flow path 78 caused by the pilot valve 70 and corresponding to the flow rate of the oil is small. Accordingly, in the damping force adjusting part 60 of the fourth embodiment, it is easy to control the flows of oil in the outer pilot flow paths 78 by the pilot valve 70 particularly in a state where the opening degree of the pilot valve 70 is small.

### Fifth Embodiment

Next, the hydraulic shock absorber 1 to which a fifth embodiment is applied will be described.

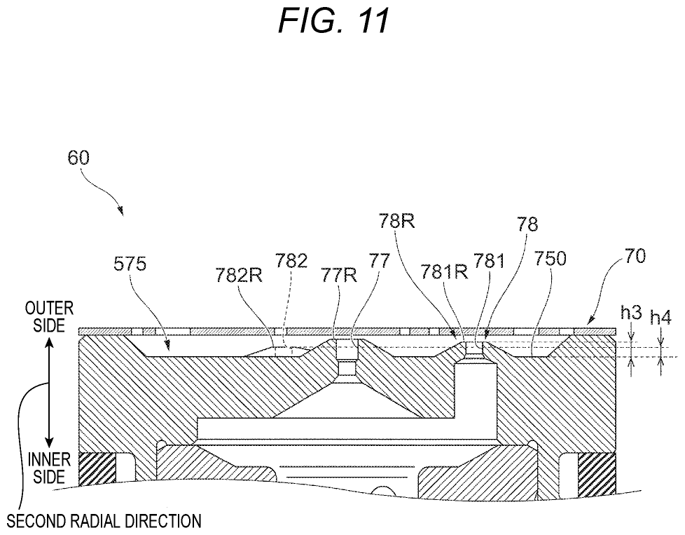

FIG. 11 is a view illustrating the damping force adjusting part 60 according to the fifth embodiment. In the description of the fifth embodiment, the same components as those of the other embodiments are denoted by the same reference numerals, and a detailed description thereof will be omitted.

In the damping force adjusting part 60 of the fifth embodiment, a configuration of a pilot valve seat 575 is different from that of the pilot valve seat 75 of the first embodiment.

In the damping force adjusting part 60 of the fifth embodiment, in the pilot valve seat 575, flow path cross-sectional areas of flow path ports of the plurality of outer pilot flow paths 78 are substantially equal to one another.

As shown in FIG. 11, in the pilot valve seat 575, protrusion heights of the outer rounds 78R of the plurality of outer pilot flow paths 78 are different from one another. For example, in the pilot valve seat 575, a protrusion height h3 of the first outer round 781R, a protrusion height h4 of the second outer round 782R, and a protrusion height h5 (not illustrated) of the third outer round 783R is lowered in this order when the bottom surface portion 750 is used as a reference.

In the pilot valve 70 of the fifth embodiment configured as described above, ease of flow of oil in each outer pilot flow path 78 differs depending on the height of the outer round 78R. In the damping force adjusting part 60 of the fifth embodiment, as the protrusion height of the outer round 78R decreases in the outer pilot flow path 78, a pressing force (pre-load) on the pilot valve 70 decreases, and ease of the flow of oil in the outer pilot flow path 78 increases. Meanwhile, in the damping force adjusting part 60 of the fifth embodiment, as the protrusion height of the outer round 78R increases in the outer pilot flow path 78, the pressing force on the pilot valve 70 increases, and the ease of the flow of oil in the outer pilot flow path 78 decreases.

Therefore, in the damping force adjusting part 60 of the fifth embodiment, a flow of oil that opens the pilot valve 70 is generated in order of the third outer pilot flow path 783, the second outer pilot flow path 782, and the first outer pilot flow path 781.

As described above, in the damping force adjusting part 60 of the fifth embodiment, the oil flows while opening the pilot valve 70 with a time difference in the plurality of outer pilot flow paths 78. In the damping force adjusting part 60 of the fifth embodiment, an amount of change in opening area of the outer pilot flow path 78 caused by the pilot valve 70 and corresponding to the flow rate of the oil is small. Accordingly, in the damping force adjusting part 60 of the fifth embodiment, it is easy to control the flows of oil in the outer pilot flow paths 78 by the pilot valve 70 particularly in a state where the opening degree of the pilot valve 70 is small.

### Sixth Embodiment

Next, the hydraulic shock absorber 1 to which a sixth embodiment is applied will be described.

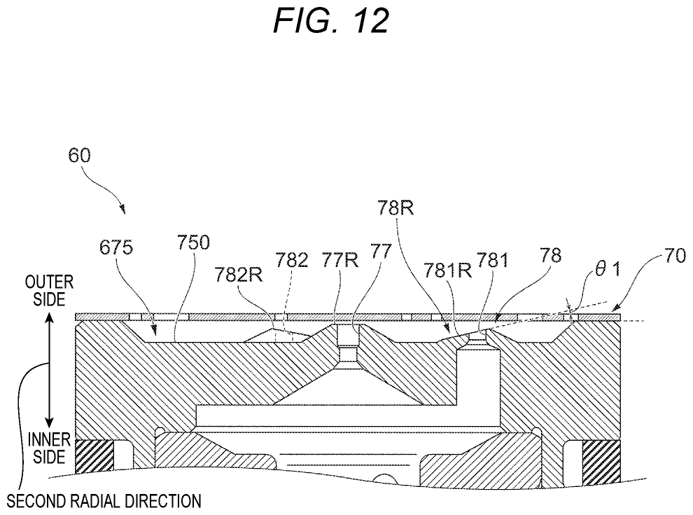

FIG. 12 is a view illustrating the damping force adjusting part 60 according to the sixth embodiment.

In the description of the sixth embodiment, the same components as those of the other embodiments are denoted by the same reference numerals, and a detailed description thereof will be omitted.

In the damping force adjusting part 60 of the sixth embodiment, a configuration of a pilot valve seat 675 is different from that of the pilot valve seat 75 of the first embodiment.

In the damping force adjusting part 60 of the sixth embodiment, in the pilot valve seat 675, flow path cross-sectional areas of flow path ports of the plurality of outer pilot flow paths 78 are equal to one another.

As shown in FIG. 12, in the outer pilot flow path 78 of the sixth embodiment, the outer round 78R is inclined with respect to the bottom surface portion 750. The outer round 78R (an example of a round portion) forms an angle θ1 with respect to a plate surface of the pilot valve 70.

In the damping force adjusting part 60 of the sixth embodiment, when the pilot valve 70 opens the outer pilot flow path 78, the outer pilot flow path 78 is gradually opened, for example, as compared to a case where the outer round 78R is not inclined. Accordingly, in the damping force adjusting part 60 of the sixth embodiment, an amount of change in opening area of the outer pilot flow path 78 caused by the pilot valve 70 and corresponding to the flow rate is small.

In each of the above-described embodiments, a configuration in which the plate-shaped pilot valve 70 is pressed against the inner pilot flow path 77 or the outer pilot flow paths 78 by the pressing member 65 is used, but the present invention is not limited to this example. For example, the pressing member 65 (an example of a deformation portion) is implemented by a member that deforms according to the flow of oil. In place of the pilot valve 70, the pressing member 65 may directly control the flow of oil with respect to the plurality of outer rounds 78R.

In this case, the pressing member 65 is deformed according to the flow of oil, so that timings at which the plurality of outer pilot flow paths 78 are opened are made different from one another. As a result, the oil flows while opening the pilot valve 70 with a time difference in the plurality of outer pilot flow paths 78. In this case, in the damping force adjusting part 60, an amount of change in opening area of the outer pilot flow path 78 caused by the pilot valve 70 and corresponding to the flow rate of the oil is also small.

Further, instead of the pilot valve 70 and the pilot valve seat 75 described above, a flow path having a plurality of opening portions communicates with the connection flow path connected to the back pressure chamber 68P. Further, a shutter member that opens and closes the plurality of opening portions is provided in order to make the oil flow through the plurality of opening portions with a time difference when the oil flows through the connection flow path. In this way, in the damping force adjusting part 60, an amount of change in opening area may be small according to a flow rate of the oil.

In the first to sixth embodiments described above, all or a part of the configuration described in one embodiment may be applied to or combined with another embodiment.

### REFERENCE SIGNS LIST

1: hydraulic shock absorber
11: cylinder
20: rod
30: piston part
50: main valve part
51: main valve
52: main valve seat
54: main flow path
60: damping force adjusting part
65: pressing member
67: cap portion
68: back pressure generating mechanism
68P: back pressure chamber
70: pilot valve
75: pilot valve seat
77: inner pilot flow path
78: outer pilot flow path
100: outer damper

What is claimed is:

1. A damping-force generation mechanism comprising:
a first flow path forming portion forming a first flow path through which a fluid flows;
a first valve configured to control a flow of the fluid in the first flow path;
a back pressure chamber configured to apply a back pressure to the first valve;
a second flow path forming portion connected to the back pressure chamber and including a plurality of second flow paths for adjusting a pressure of the fluid in the back pressure chamber; and
a second valve provided to face the second flow path forming portion and configured to control flows of the fluid in the plurality of second flow paths, the second valve being opened with a time difference between at least one second flow path of the plurality of second flow paths and another second flow path of the plurality of second flow paths when the fluid flows.

2. The damping-force generation mechanism according to claim 1, wherein
the one second flow path and the other second flow path have different shapes.

3. The damping-force generation mechanism according to claim 2, wherein
in the one second flow path and the other second flow path, flow path cross-sectional areas of flow path ports thereof facing the second valve are different.

4. The damping-force generation mechanism according to claim 2, wherein
the one second flow path and the other second flow path have different protrusion heights toward the second valve.

5. The damping-force generation mechanism according to claim 1, wherein
the second flow path forming portion includes protrusion portions respectively provided adjacent to the one second flow path and the other second flow path and protruding toward the second valve so as to be contactable with the second valve.

6. The damping-force generation mechanism according to claim 1, wherein
the second flow path forming portion includes round portions each provided around a flow path port of the second flow path, protruding annularly toward the second valve, and inclined with respect to the second valve.

7. The damping-force generation mechanism according to claim 1, wherein
the second valve has different rigidities at regions respectively facing the one second flow path and the other second flow path.

8. The damping-force generation mechanism according to claim 7, wherein
the second valve includes a plurality of elastic members having different shapes.

9. The damping-force generation mechanism according to claim 1, wherein
the second valve includes a deformation portion that is provided at an end portion of an advancing and retreating unit configured to advance and retreat according to an energized state, and that is deformed according to a flow of the fluid in the second flow path.

10. A pressure shock absorber comprising:
a cylinder configured to accommodate a fluid;
a piston part connected to a rod, that moves in an axial direction, and configured to move in the cylinder;
a first flow path forming portion forming a first flow path through which the fluid flows along with a movement of the piston part;
a first valve configured to control a flow of the fluid in the first flow path;
a back pressure chamber configured to apply a back pressure to the first valve;
a second flow path forming portion connected to the back pressure chamber and including a plurality of second flow paths for adjusting a pressure of the fluid in the back pressure chamber; and
a second valve provided to face the second flow path forming portion and configured to control flows of the fluid in the plurality of second flow paths, the second valve being opened with a time difference between at least one second flow path of the plurality of second flow paths and another second flow path of the plurality of second flow paths when the fluid flows.

11. A damping-force generation mechanism comprising:
a first flow path forming portion forming a first flow path through which a fluid flows;
a first valve configured to control a flow of the fluid in the first flow path;
a back pressure chamber configured to apply a back pressure to the first valve;
a second flow path forming portion connected to the back pressure chamber and including a plurality of outer pilot flow paths for adjusting a pressure of the fluid in the back pressure chamber; and
a second valve provided to face the second flow path forming portion and configured to control flows of the fluid in the plurality of outer pilot flow paths, the second valve being opened with a time difference between at least one outer pilot flow path of the plurality of outer pilot flow paths and another outer pilot flow path of the plurality of outer pilot flow paths when the fluid flows.

12. The damping-force generation mechanism according to claim 11, wherein
the one outer pilot flow path and the other outer pilot flow path have different shapes.

13. The damping-force generation mechanism according to claim 12, wherein
in the one outer pilot flow path and the other outer pilot flow path, flow path cross-sectional areas of flow path ports thereof facing the second valve are different.

14. The damping-force generation mechanism according to claim 12, wherein
the one outer pilot flow path and the other outer pilot flow path have different protrusion heights toward the second valve.

15. The damping-force generation mechanism according to claim 11, wherein
the second flow path forming portion includes protrusion portions respectively provided adjacent to the one outer pilot flow path and the other outer pilot flow path and protruding toward the second valve so as to be contactable with the second valve.

16. The damping-force generation mechanism according to claim 11, wherein
the second flow path forming portion includes round portions each provided around a flow path port of the outer pilot flow path, protruding annularly toward the second valve, and inclined with respect to the second valve.

17. The damping-force generation mechanism according to claim 11, wherein
the second valve has different rigidities at regions respectively facing the one outer pilot flow path and the other outer pilot flow path.

18. The damping-force generation mechanism according to claim 17, wherein
the second valve includes a plurality of elastic members having different shapes.

19. The damping-force generation mechanism according to claim 11, wherein
the second valve includes a deformation portion that is provided at an end portion of an advancing and retreating unit configured to advance and retreat according to an energized state, and that is deformed according to a flow of the fluid in the outer pilot flow path.

20. The pressure shock absorber according to claim 10, wherein
the plurality of second flow paths are a plurality of outer pilot flow paths.
